(19) United States
(12) Patent Application Publication
(10) Pub. No.: US 2014/0095518 A1
(43) Pub. Date: Apr. 3, 2014

(54) CALCULATED MEASURES AS ATTRIBUTE FILTERS

(71) Applicant: SAP AG, Walldorf (DE)

(72) Inventors: Thomas Schneider, Heidelberg (DE); Christian Conradi, Walldorf (DE)

(73) Assignee: SAP AG, Walldorf (DE)

(21) Appl. No.: 13/679,259

(22) Filed: Nov. 16, 2012

Related U.S. Application Data
(60) Provisional application No. 61/707,604, filed on Sep. 28, 2012.

(51) Int. Cl. G06F 7/24

(52) U.S. Cl. CPC G06F 7/24
USPC 707/754

(57) ABSTRACT

Systems and methods for using calculated measures as attribute filters are provided. In example embodiments, a query for a result set is processed. The query includes a filter attribute that is absent from a base table from which the result set is to be obtained. A set of measures associated with the filter attribute that is absent from the base table is calculated. The base table is extended to include the calculated set of measures associated with the filter attribute that is absent from the base table to create an extended table. The extended table is filtered based on the filter attribute to create a filtered extended table. The result set is derived using the filtered extended table.

### CROSS-REFERENCE TO RELATED APPLICATIONS

This application claims the benefit of U.S. Provisional Application No. 61/707,604, filed Sep. 28, 2012, entitled “CALCULATED MEASURES AS ATTRIBUTE FILTERS,” which is incorporated herein by reference in its entirety.

### FIELD

The present disclosure relates generally to data analysis, and in a specific example embodiment, to using calculated measures as attribute filters.

### BACKGROUND

Generally, users use an attribute or characteristic of a base table (e.g., fact table) to filter the information within the base table. That is, the user typically picks an attribute with explicit values within the base table to filter the data in the table.

### BRIEF DESCRIPTION OF DRAWINGS

Various ones of the appended drawings merely illustrate example embodiments of the present invention and cannot be considered as limiting its scope.

FIG. 1 illustrates an environment in which example embodiments of the inventive subject matter may be practiced.

FIG. 2A is a schematic architecture of an example embodiment.

FIG. 2B is a block diagram of an example filtering system.

FIG. 3 is a block diagram illustrating a star scheme for tables within memory.

FIG. 4A is a table that illustrates an example scenario of an application of the example embodiments.

FIG. 4B is a table that illustrates the example scenario of the application of the example embodiments.

FIG. 4C is a table that illustrates the example scenario of the application of the example embodiments.

FIG. 4D is a table that illustrates the example scenario of the application of the example embodiments.

FIG. 4E is a table that illustrates the example scenario of the application of the example embodiments.

FIG. 4F is a table that illustrates the example scenario of the application of the example embodiments.

FIG. 4G is a table that illustrates the example scenario of the application of the example embodiments.

FIG. 4H is a table that illustrate the example scenario of the application of the example embodiments.

FIG. 5 is a flowchart of an example method for using calculated measure as attribute filters.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods for using calculated measures as attribute filters are provided. In example embodiments, different transactional database tables are combinable with corresponding master data tables. SQL statements with explicit summarization are executed against the combined database tables to obtain specific aggregated or calculated measures (e.g., key figures) for a chosen set of attribute value combinations. These calculated measures may be used as filters to arrive at a final result set of data.

More specifically, a query for a result set is processed. The query includes a filter attribute that is absent from a base table from which the result set is to be obtained. A set of measures associated with the filter attribute that is absent from the base table is calculated. The base table is extended to include the calculated set of measures associated with the filter attribute that is absent from the base table to create an extended table. In example embodiments, a table may be a database table or a database view. That is, the extended table may be a database view that provides an extended result set. The extended table or database view is filtered based on the filter attribute to create a filtered extended table or database view. The result set is derived using the filtered extended table or database view.

Besides a standard process to filter measures via explicit values of the directly associated master data attributes (e.g., revenue for product “laptop,” “mouse,” or “keyboard”), the process may filter via values of further aspects describing their attributes. Accordingly, example embodiments calculate values of measures for specific attributes and use these calculated values as filters for the selection. For example, revenues for products may be initially calculated. The revenues may then be used as filters to restrict the final results for which an overall revenue may be calculated. Respective queries may be, for example, calculating an overall revenue for each country where at least one product is sold that has a (product) revenue of greater than a particular amount, or calculating the overall revenue per country where at least one product is sold that has a (product) revenue of greater than a particular amount but take only products into account which fit into the revenue filter.

In a more specific example, a set of attribute value combinations may be revenue per product and country. For example, a database may store information regarding revenues for a plurality of products, including automobiles, for one or more time frames for various countries including the U.S. The revenues for product “automobile” in December may total $10 million, while a total revenue for the US (calculated using revenues for all products in the US for December) is $10 billion. In this example, the original model (e.g., database with revenue per product based on time and country; also known as abuse table) may be extended with the information for the total revenue for all countries. Subsequently, the calculated total revenue of countries may be used to filter the original data to find products, for example, in countries where the total revenue of a country is over $10 billion in the month of December. Thus, a measure that is calculated on-the-fly (e.g., total revenue for a country in December) is used as a filter to obtain a result set. To extend the example further, a query may request a list of products with annual revenues of over $50 million in countries with total revenues of over $10 billion in the month of December. In this case, not only are total revenues for countries calculated on-the-fly and used as filters, the total revenues for each product in each country over a time frame of a year are calculated. All these calculations may be joined into an extended set of data (e.g., database table or views) for filtering. Thus, filter attributes, which may be attributes describing attributes, are calculated on-the-fly and used to filter the data set.

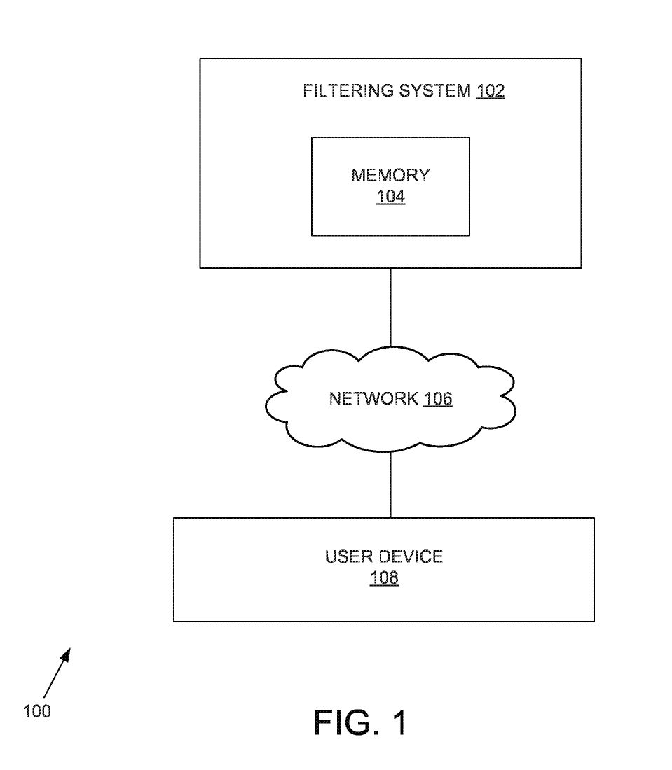

With reference to FIG. 1, an environment 100 in which example embodiments of the inventive subject matter may be practiced is shown. The environment 100 comprises a filtering system 102 having a memory 104 that is communicatively coupled via a network 106 to a user device 108. The network 106 may comprise the Internet, a wireless network, a cellular network, a Wide Area Network (WAN), or any other type of network which allows for exchange of communications. The user device 108 is associated with a user that submits a query to the filtering system 102. The query may indicate a filter attribute that is not directly stored on a base table. The query triggers the filtering system 102 to calculate measures associated with the filter attribute that may be used to filter on the base table as will be discussed in more detail below.

The memory 104 forms a memory-based database platform which allows for fast processing of large data volumes. Complete database tables are kept in the memory 104 to be processed immediately (e.g., on-the-fly). The memory 104 may comprise various components that can process the data from the database tables. The components within the memory 104 will be discussed in more detail below. This embodiment allows for fast in-memory processing and calculations. For example, the filtering system 102 may be implemented using an extended stored procedure technology (e.g., SAP HANA).

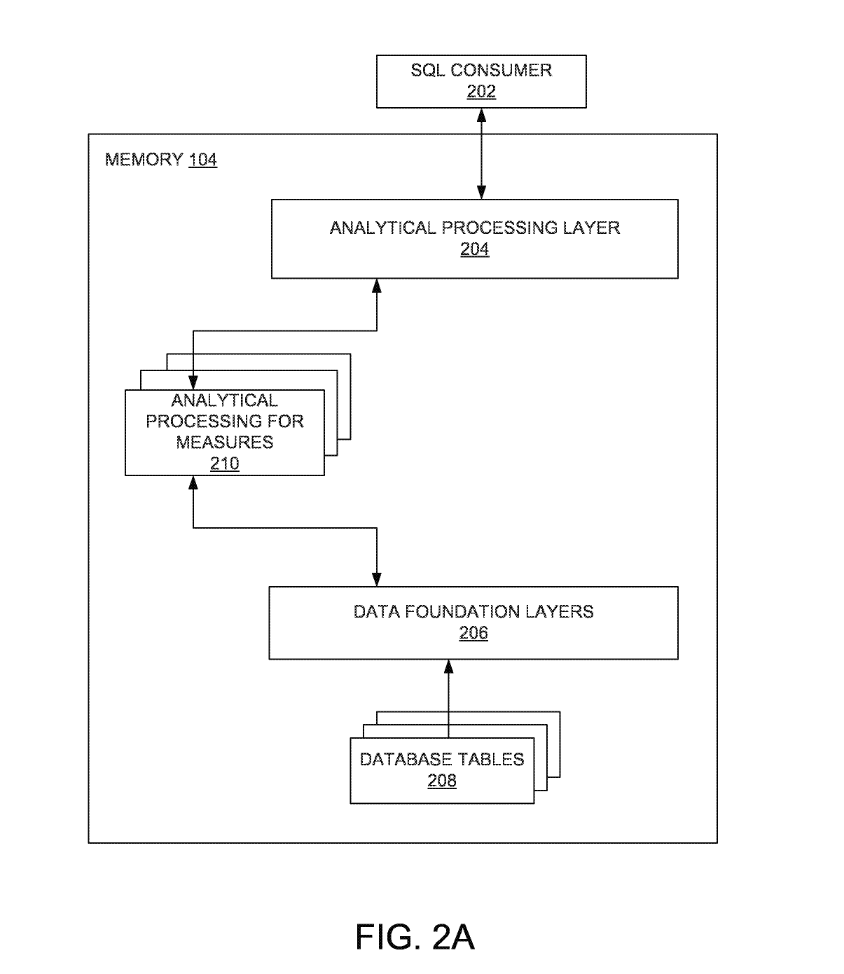

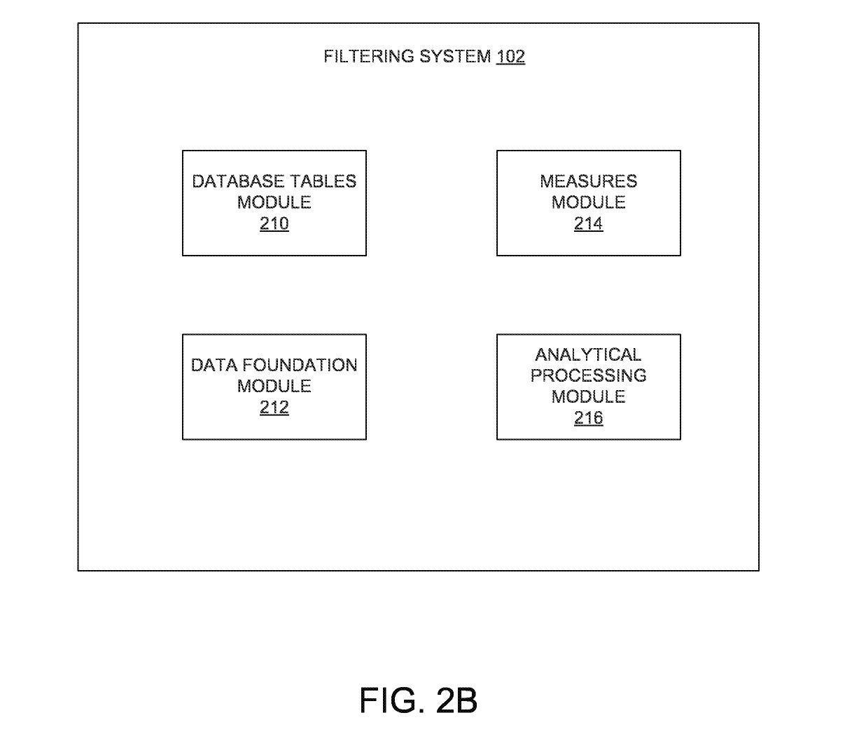

FIG. 2A is schematic architecture in accordance with an example embodiment. The architecture comprises the memory 104 communicatively coupled to a SQL consumer 202. In example embodiments, the SQL consumer 202 (e.g., a user device) provides the query indicating an attribute filter. The SQL consumer 202 triggers the processing and analysis within the memory 104. The processing includes calculation of the measures (also referred to as “key figures”) associated with the filter attribute to be used as filters. The SQL consumer 202 also causes the results of the application of the measures as filters to be provided back to a user. In some embodiments, the memory 104 may be a part of the SQL consumer 202.

The memory 104 comprises an analytical processing layer 204, a data foundation layer 206, and a set of database tables 208. The database tables 208 comprise one or more fact tables and master data tables. The database tables 208 provide a basic model or view of a set of fields. In example embodiments, the database tables 208 are stored in column based format, which unlike conventional database management systems, does not store the data records as table lines together at one position in the main memory. Instead, the columns may be kept in a local position in the database main memory, which allows for fast aggregation of values in the columns. The use of columns is also optimal for aggregating multiple values from selected columns instead of reading complete data records/lines as with convention systems.

In example embodiments, the triggering by the SQL consumer 202 causes the analytical processing layer 204 to call data views in order to calculate attribute specific measures. The analytical processing layer 204 may define and provide the attributes and measures needed for analytical investigation by performing analytical processing for measures 210 and the data foundation layer 206. Thus, the analytical processing layer 204 consumes the data from the data foundation layer 206 to provide analytical results in a requested way as measures per attribute values.

To enrich the analytical processing layer 204 with measures as filterable attributes, specific views are created by the analytical processing for measures 210 that calculate the request key figures for one or more attributes (e.g., filter attribute in the query). That is, the call causes analytical processing for measures 210 for a specific attribute. In one embodiment, each analytical processing for measures 210 calculates measures for a different attribute. Thus, each of the single views acts as a small view which is a result of processing the data from the data foundation layer 206 to calculate the measures in a separate way.

The calculation of the measures may trigger a data process request to the data foundation layer 206. In response, the data foundation layer 206 processes the data request. In example embodiments, the data foundation layer 206 provides access to the database tables 208 with predefined join conditions to reflect the business logic of the elementary tables. The data foundation layer 206 returns processed data in the form of joined tables, which provide a comprehensive set of fields taken from the various database tables 208.

The analytical processing layer 204 may then extend a base table with the calculated measures to create an extended database table or view. Once extended, the filter(s) can be applied to the extended table or view to determine filter-satisfying rows of data in the extended table or view. The analytical processing module 204 may then derive the result set for the query using the data in the filter-satisfying rows.

The architecture of FIG. 2A is merely an example, and alternative embodiments may comprise any number of database tables 208 and analytical processing for measures 210. Additionally, while example embodiments are discussed using SQL, alternative embodiments may contemplate the user of any language.

FIG. 2B is a block diagram of an example filtering system 102. The filtering system 102 may comprise a database tables module 210, a data foundation module 212, a measures module 214, and an analytical processing module 216. It is noted that components and functions of the filtering system 102 may be combined, separated, or located elsewhere in the environment 100.

In example embodiments, the database table module 210 accesses the database tables 208. The information in the database tables may then be used by the database foundation module 212. In example embodiments, the data foundation module 212 performs functions corresponding to the data foundation layer 206 by processing a data request and returning processed data in the form of joined tables, which provide a comprehensive set of fields taken from the various database tables 208.

The analytical processing of measures 210 of FIG. 2A may correspond to or be performed by one or more measure modules 214. In example embodiments, the measure module 214 uses data calculated by the data foundation module 212 to calculated specific attributes. The results may be used to enrich the analytical processing layer 204 with measures as filterable attributes.

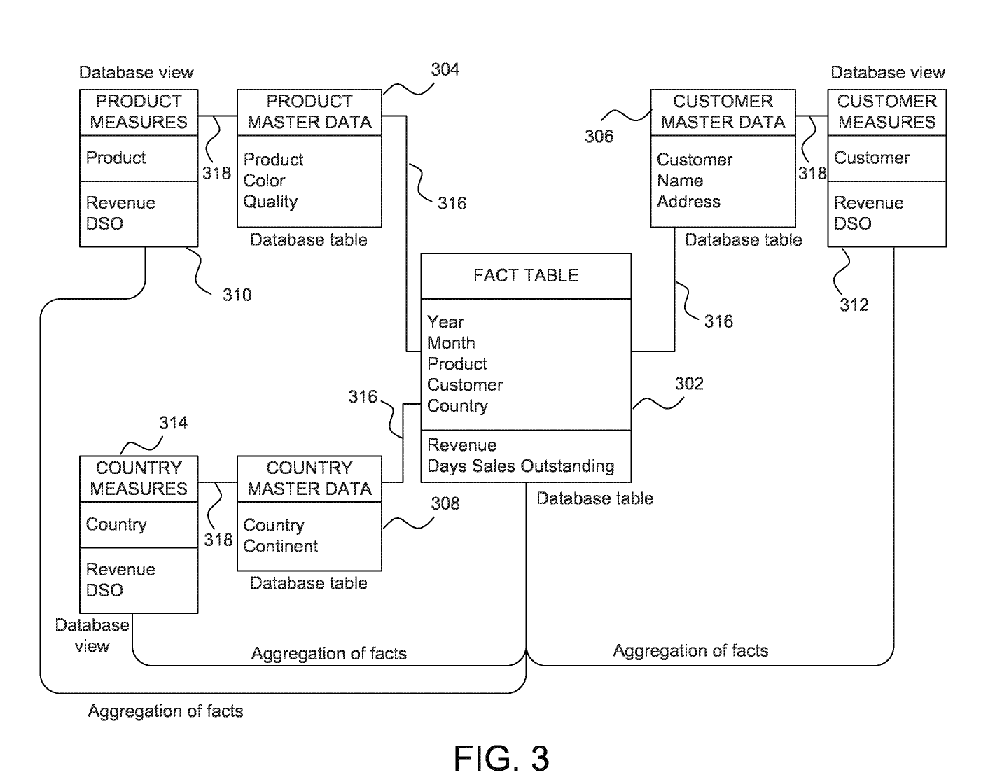

The analytical processing module 216 corresponds to functions of the analytical processing layer 204 by defining and providing the attributes and measures needed for analytical investigation by the measures module 214 and the data foundation module 212. Thus, the analytical processing module 216 uses the data from the data foundation module 212 to provide analytical results in a requested way as measures per attribute values. FIG. 3 is a block diagram illustrating a star scheme for tables within the memory 104. The entirety of the data found in the tables of FIG. 3 may be combined in a database view corresponding to the analytical processing layers 204 which is consumable by the SQL consumer 202. Example embodiments provide additional filterable columns to the base tables (e.g., fact table) including calculated measures (key figures) that may be calculated for each of master data attribute and used as further filtering attributes. As such, a basic model (e.g., modeled view) may be a data view that is joined with one or more additional data views.

Referring to FIG. 3, the model (e.g., model view) provides joins between the fact table 302 (e.g., base table) and corresponding master data tables 304, 306, and 308. The fact table 302 contains main attribute keys and measures. For example, the fact table 302 includes specific factual data regarding year, month, product, customer, country, revenue, and days sales outstanding (DSO).

In contrast, the master data tables 304, 306, and 308 provide further information on the main attributes (e.g., attributes describing the main attributes in the fact table 302). The master data is generally a set of data that defines categories or other persisted information. For example, the product master data table 304 includes data regarding product (e.g., laptop, mouse, keyboard), color (e.g., red, black), and quality, while the customer master data table 306 includes data regarding customer (e.g., type), name (e.g., Apple, Sony) and address. The country master data table 308 may include data regarding specific countries (e.g., USA, France, Germany) and continents (e.g., North America, Europe).

As illustrated in FIG. 3, the master data tables 304, 306, and 308 are arranged around the fact table 302 in a star format resulting in a star schema. In example embodiments, the fact table 302 and the master data tables 304, 306, and 308 may be stored in the memory 104 (e.g., as the database tables 208).

Product measures 310, customer measures 312, and country measures 314 are database views which are not persisted, but calculated during runtime (on-the-fly) by the measure modules 210. Thus, the product measures 310, the customer measures 312, and the country measures 314 are calculated measures for the main attributes that, when joined to the fact table 302 and master data tables 304, 306, and 308 extend the basic star schema. Thus, the measures 310-314 may be considered aggregations of database tables realized as database views.

In essence, the database views of the product measures 310, customer measures 312, and country measures 314 are, themselves, queries on the original star schema and calculated measures relative to one attribute each via projections and aggregations. Thus, the measures 310-314 are database views based on, and aggregating data of, the fact table 302 via a join 318 with a master data table 304-308. It is noted that joining a master data table 304-308 is optional and may only be required if explicit information from the master data tables 304-308 is required from a business perspective. In some instances, the join 318 may be performed with the fact table 302 instead. In example embodiments the joins 318 between the database tables and the aggregating of database views (of the measures 310-314) are realized via extended database views in the analytical processing layers 204.

In the example, the product measure 310 may be data indicating revenue and days sales outstanding for specific products, while the customer measures 312 is data indicating revenue and days sales outstanding for specific customers, and the country measures 314 are data indicating revenue and days sales outstanding for specific countries. It is noted that the calculated measures may be any data calculated on-the-fly (e.g., not persisted) that is related to a specific dimension of the data or attribute found in the fact table 302 or master data tables 304, 306, and 308. An example scenario utilizing the various tables and measures discussed in FIG. 3 is provided below.

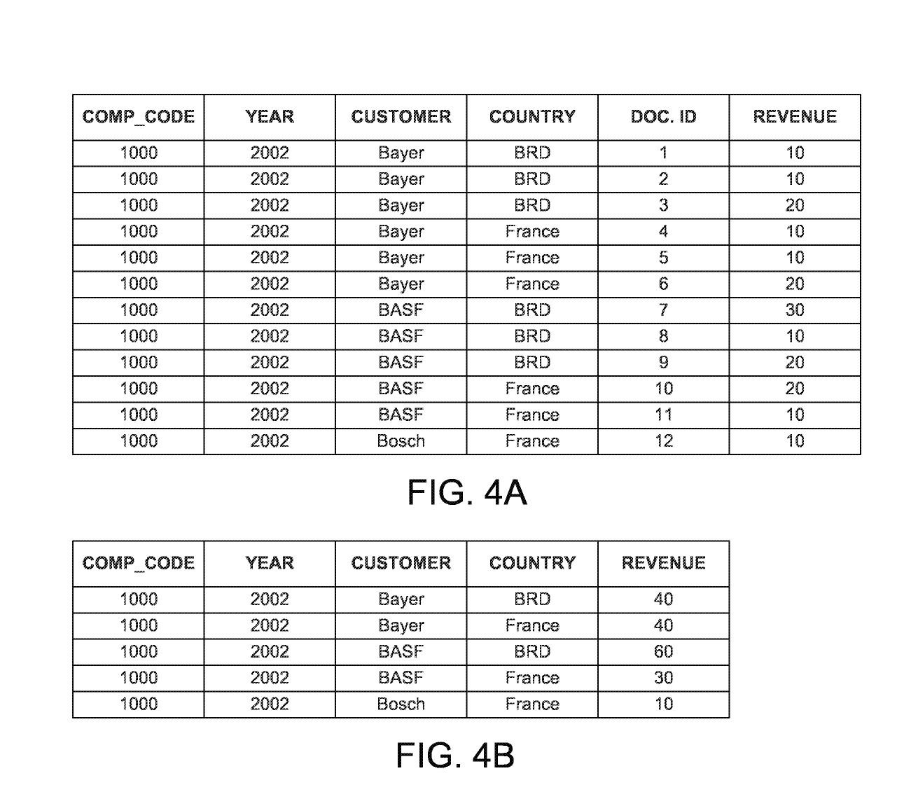

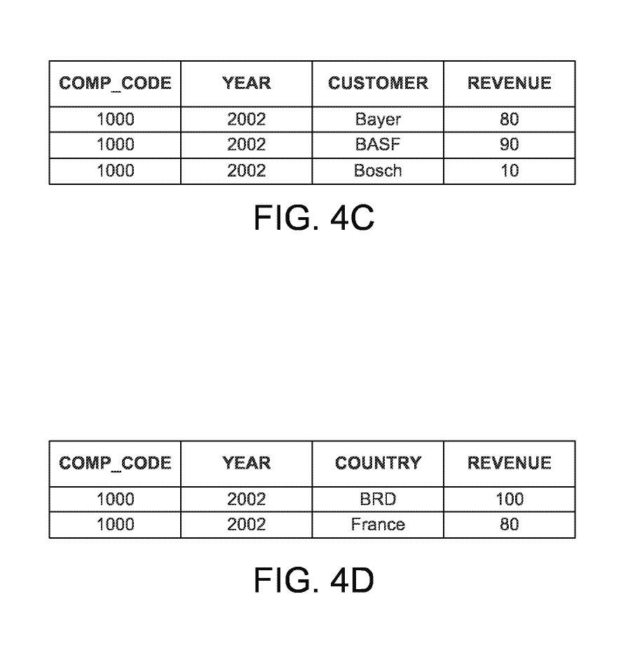

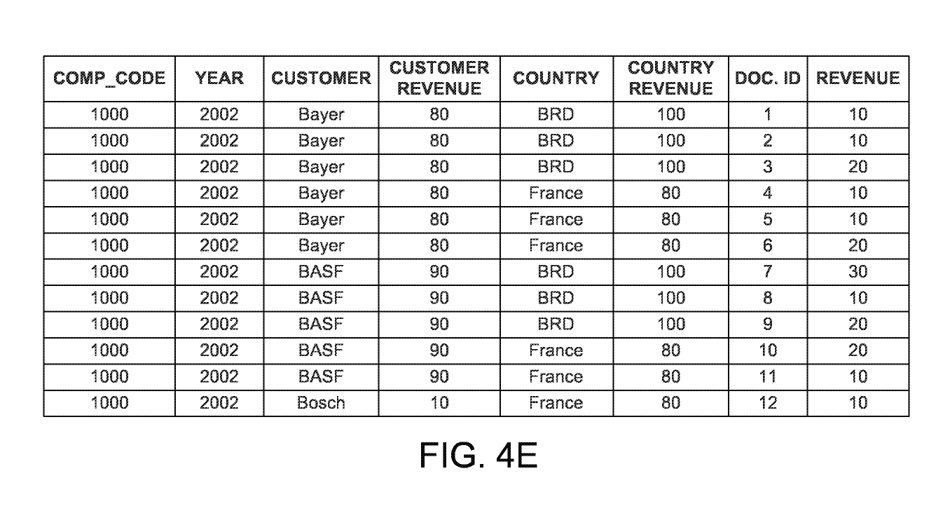

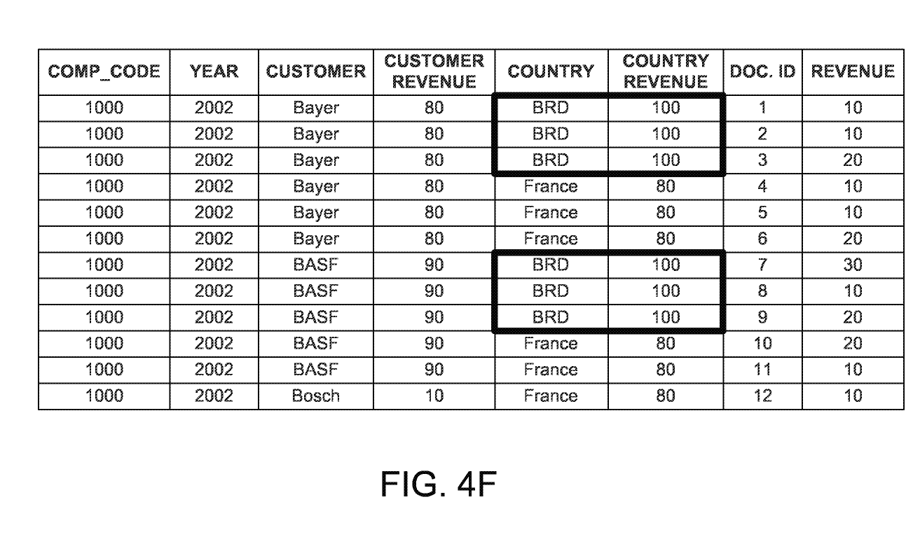

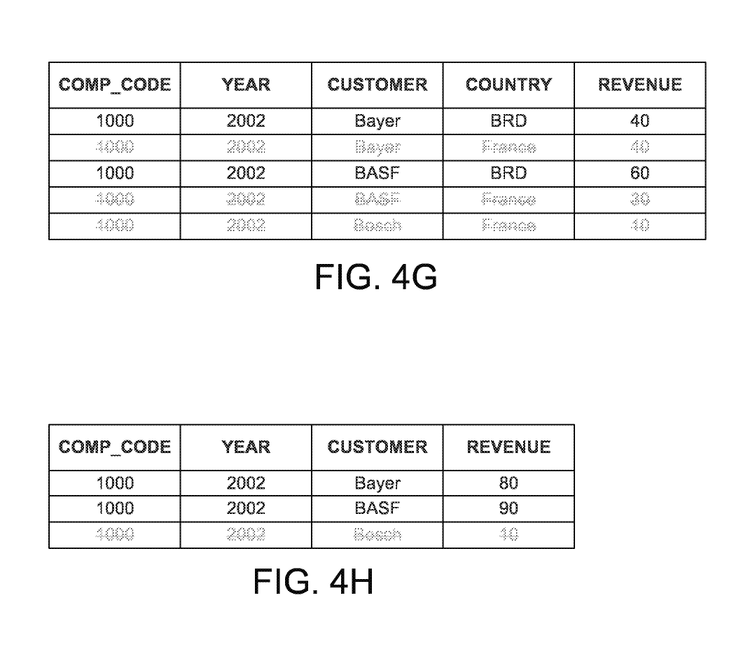

FIG. 4A-4H are tables that illustrate an example scenario of an application of the example embodiments. In this example scenario, a query may be received that requests a result that includes total company revenue for companies doing business in countries with a total country revenue of between $90 million and $110 million. Thus, the filter attribute comprises total country revenues. It is noted that more than one filter attribute may be included in a query.

Referring to FIG. 4A, a base table (also referred to as a basis table) is shown. In the present scenario, the base table comprise a table of accounting documents for an organization (e.g., company code 1000). The base table may be generated from a plurality of separate database tables (e.g., database tables 208) stored in memory 104. According to the base table, the documents are created in the year 2002 for several customers (e.g., Bayer, BASF, and Bosch) of the organization. The base table also provides information regarding the country of origin for the company. As shown, a customer (e.g., Bayer) may have more than one country of origin (e.g., Germany (BRD) and France), which indicates that the customer has more than one location engaging in business with the organization (e.g., company code 1000) for which a document is created. Furthermore, a list of document identifiers and revenues (e.g., shown in millions of dollars) for each document is indicated in the base table. The base table does not include the filter attribute (e.g., total revenues for each country).

Referring now to FIG. 4B, a first analysis is performed (e.g., by the analytical processing for measures 210 or the measure modules 214) on the base table that results in the table of FIG. 4B. The table of FIG. 4B shows revenue for company 1000 (e.g., from com_code) with existing combinations of customers and countries with no further filters applied to the base table of FIG. 4A. For example, total revenues for company 1000 with Bayer in Germany (BRD) is $40 million and in France is $40 million.

A further analysis may be performed whereby the key attributes are the customer and the country. For example, the measure modules 214 calculate the respective revenue measures for each customer (FIG. 4C) and the respective revenue measures for each country (FIG. 4D) in queries to corresponding views. For example, total revenues with Bayer is $80 million (across all countries) while total revenues with BASF is $90 million as shown in FIG. 4C. The total revenue in Germany is $100 million for all customers listed in the base table shown in FIG. 4A, while the total revenue in France is $80 million for all customers listed in the base table.

The calculated measures of revenue per customer and revenue per country are used to extend the base table attributes with further characteristics (e.g., attributes describing attributes). FIG. 4E illustrates the extension of the base table to include the calculated measures of revenue per customer (shown as “customer revenue”) and revenue per country (shown as “country revenue”). The new columns of data (e.g., customer revenue, country revenue) may be used to filter the extended table in order to select rows that may be the new basis for subsequent calculations of a final revenue measure.

Referring now to FIG. 4F, the attribute filter for all countries with revenues between $90 million and $110 million is applied by the analytic processing layer 204 or the application processing module 216. In this example, Germany (BRD) is the only attribute that satisfies the filter condition (e.g., $90 million≦country revenue≦$110 million). As a result, rows 1-3 and 7-9 remain after the other rows are filtered out.

The results of the filter applied in FIG. 4F (e.g., filter of country revenue between $90 million and $110 million) may be applied on the extended table to filter countries. The result for the filtered data may be a table as shown in FIG. 4G, which reduces the table of FIG. 4B from five rows of data to two rows of data. Specifically, the rows for Bayer/BRD (e.g., Germany) and BASF/BRD remain while rows with country “France” are removed.

A further analysis may be performed, for example, that filters on total revenue for companies in countries with revenues between $90 million and $110 million by the analytical processing layer 204 or the analytical processing module 216. As shown in FIG. 4H, the two remaining customers (e.g., Bayer and BASF) are shown with total revenues across all countries even though the filter is based on countries with revenues between $90 million and $110 million. Thus, for the query for customers in countries with total revenues of between $90 million and $110 million, the result will be Bayer with $80 million in revenue and BASF with $90 million in revenue. As shown, the results are determined using measures that were calculated on-the-fly and used to extend the base table such that the measures may be used to filter the extended table.

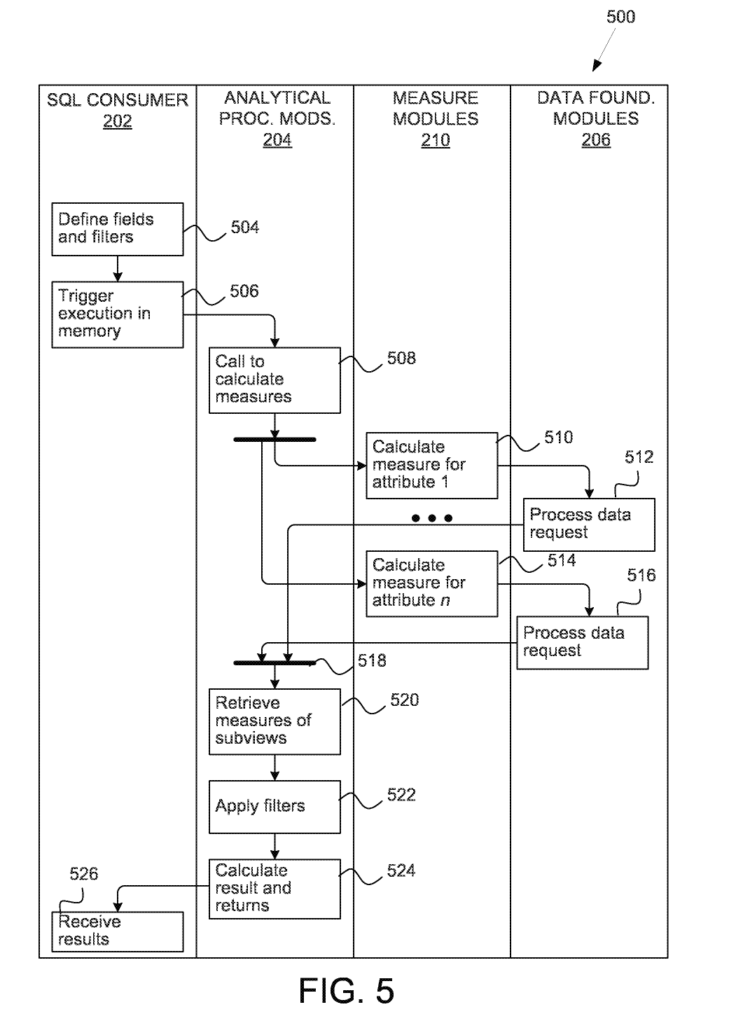

FIG. 5 is a flowchart 500 of an example method for using calculated measure as attribute filters. The operations of FIG. 5 may be performed by various components (e.g., the SQL consumer 202, the analytical processing layers 204, the analytical processing for measures 210, and the data foundation layers 206 or their corresponding modules 212-216) of the filtering system 102. In some embodiments, the filtering system 102 may be embodied on a device (e.g., server) of a service provider, while in other embodiments the filtering system 102 is embodied on, or associated with, the user device 108.

In operation 504, the SQL consumer 202 sets-up the query by defining fields and filters. The fields and filters may comprise a complete list of what data is to be retrieved, other dimensions, or key figures for the dimensions. For example, more detailed information about the set of customers with revenues within a certain range may be desired. The range of the key figure is specified. The SQL consumer 202 then triggers the processing and analysis within the memory 104 in operations 506. In example embodiments, the SQL consumer 202 may provide an indication of the defined fields and filters (e.g., the range of the key figure) in the trigger.

In operation 508, the analytical processing layers 204 (or the corresponding analytical processing module 216) receive the trigger from the SQL consumer 202 and call the analytical processing for measures 210 (or the corresponding measure modules 214) to calculate the attribute specific measures. The analytical processing layer 204 provide the attributes (e.g., countries, companies) and measures (e.g., total revenue per country, total revenue per company) needed for analytical investigation to the analytical processing for measures 210. The measures (also referred to as “key figures”) may be used as one or more filters for the query and may be related to the indicated defined filters of operation 504. Depending on the number of filters, multiple calls may be made by the analytical processing layers 204. As such, the analytical processing layer 204 may call the single views in parallel to its own call of the data foundation layer 206 (or the data foundation module 212) to trigger the data processing.

The call of views causes one or more analytical processing for measures 210 to calculate measures for specific attributes. Thus, in operation 510, one or more measures for attribute 1 are calculated. The calculation may comprise sending a data request to the data foundation layers 206 to process in operation 512. Continuing with the example, the analytical processing for measures 210 calculate the key figure (e.g., total revenues per customer) and the list (e.g., of customers) identified by the view is passed to the data foundation layer 206. The returned processed data may be sent back via an SQL statement, for example, with the additional dimensions.

In example embodiments, the calculation of the measures for each attribute is performed by a different analytical processing for measures 210 (operation 514) which triggers a separate data request process at the data foundation layer 206 (operation 516). In example embodiments, the data foundation layer 206 processes the data requests (operations 512 and 516) and return processed data in the form of joined tables. These joined tables provide a comprehensive set of fields taken from the various database tables 208. Continuing with the example, the next aggregation may be performed for just dimensions that have been requested (e.g., revenues aggregated for a country over time). For example, the aggregated data includes a list of corresponding countries where the customers are located and total revenues per customer and country over a particular period of time.

The results of each processed data request (e.g., measures of the views) may be aggregated (operation 518) by the analytical processing layer 204 and exposed as database views which join the fact table 302 with the measures 310-314. When all measures of the views are calculated, the analytical processing layer 204 retrieves the measures in operation 520. The retrieved measures may extend the base table with calculated measures that can be filtered upon. Filters are then applied in operation 522 on the calculated measures. Using the filters, the analytical processing layer 204 calculates the results (e.g., retrieves the proper data set) and returns the results in operation 524. Continuing with the example, an aggregation of all countries where customers are found is performed as well as for the time and the corresponding revenues. The aggregation is then filtered down using a measure of the aggregation (e.g., countries with total revenue within a specified range). The result may indicate total revenue for companies doing business in the countries with total revenue within the specified range. In operation 526, the SQL consumer 202 receives the results.

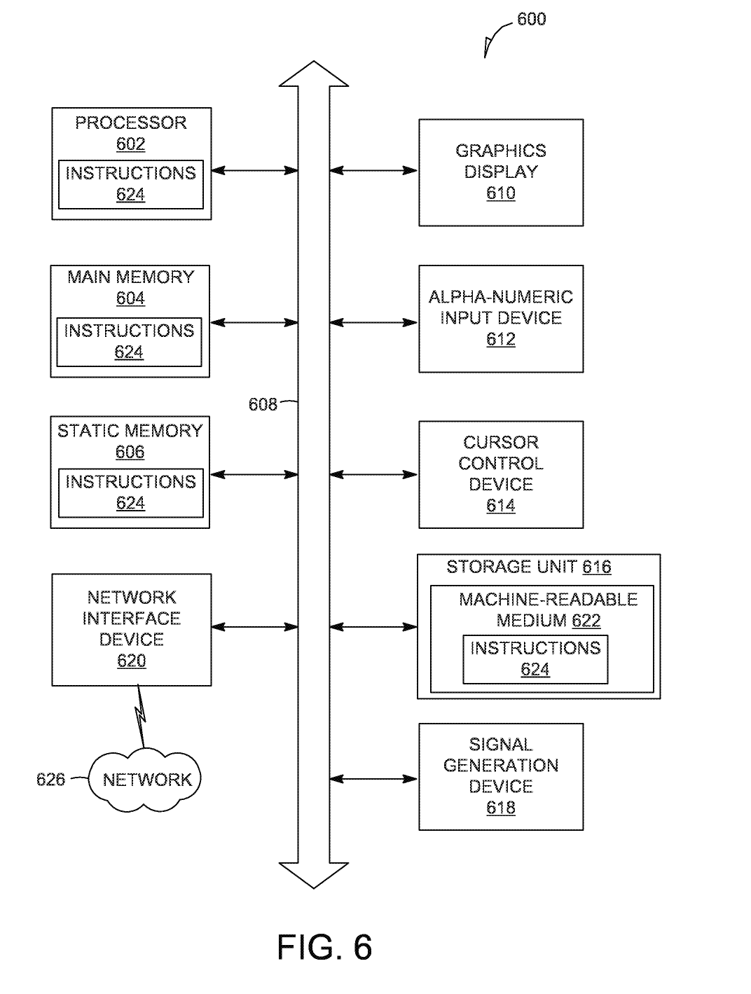

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard), a cursor control device 6)4 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually, or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
triggering processing of a query for a result set, the query including a filter attribute that is absent from a base table from which the result set is to be obtained;
calculating, using a processor of a machine, a set of measures associated with the filter attribute that is absent from the base table;
extending the base table to include the calculated set of measures associated with the filter attribute that is absent from the base table to create an extended table;
filtering the extended table based on the filter attribute to create a filtered extended table; and
deriving the result set using the filtered extended table.

2. The method of claim 1, further comprising calculating a second set of measures based on the query, wherein the extending of the base table further includes using the second set of measures along with the calculated set of measures to create the extended table.

3. The method of claim 2, wherein the deriving of the result set comprises selecting a portion of the second set of measures that remains in the filtered extended table to create the result set.

4. The method of claim 1, wherein the calculating, extending, filtering, and deriving are performed within memory of a filtering system.

5. The method of claim 1, wherein the base table is a combination of a plurality of database tables stored in memory.

6. The method of claim 1, wherein the calculating of the set of measures comprises joining two or more of a plurality of database tables stored in memory to provide a comprehensive set of fields.

7. The method of claim 1, wherein the filtering of the extended table comprises selecting rows of data in the extended table that satisfy the filter attribute.

8. The method of claim 7, wherein the deriving of the result set comprises selecting, based on the query, a portion of data in the selected rows of data that satisfy the filter attribute to create the result set.

9. A machine-readable storage medium in communication with at least one processor, the machine-readable storage medium storing instructions which, when executed by the at least one processor of a machine, cause the machine to perform operations comprising:
triggering processing of a query for a result set, the query including a filter attribute that is absent from a base table from which the result set is to be obtained;
calculating a set of measures associated with the filter attribute that is absent from the base table;
extending the base table to include the calculated set of measures associated with the filter attribute that is absent from the base table to create an extended table;
filtering the extended table based on the filter attribute to create a filtered extended table; and
deriving the result set using the filtered extended table.

10. The machine-readable storage medium of claim 9, wherein the operations further comprise calculating a second set of measures based on the query, wherein the extending of the base table further includes using the second set of measures along with the calculated set of measures to create the extended table.

11. The machine-readable storage medium of claim 10, wherein the deriving of the result set comprises selecting a portion of the second set of measures that remains in the filtered extended table to create the result set.

12. The machine-readable storage medium of claim 10, wherein the calculating, extending, filtering, and deriving are performed within memory of a filtering system.

13. The machine-readable storage medium of claim 9, wherein the base table is a combination of a plurality of database tables stored in memory.

14. The machine-readable storage medium of claim 9, wherein the calculating of the set of measures comprises joining two or more of a plurality of database tables stored in memory to provide a comprehensive set of fields.

15. The machine-readable storage medium of claim 9, wherein the filtering of the extended table comprises selecting rows of data in the extended table that satisfy the filter attribute.

16. The machine-readable storage medium of claim 15, wherein the deriving of the result set comprises selecting, based on the query, a portion of data in the selected rows of data that satisfy the filter attribute to create the result set.

17. A system comprising:
a processor of a machine;
a consumer to trigger processing based on a query for a result set, the query including a filter attribute that is absent from a base table from which the result set is to be obtained;
a measure module to calculate, using the processor, a set of measures associated with the filter attribute that is absent from the base table; and
an analytical processing module to extend the base table to include the calculated set of measures associated with the filter attribute that is absent from the base table to create an extended table, to filter the extended table based on the filter attribute to create a filtered extended table, and to derive the result set using the filtered extended table.

18. The system of claim 17, further comprising:
a second measure module to calculate a second set of measures based on the query, wherein the base table is extended by using the second set of measures along with the calculated set of measures to create the extended table, and
wherein the analytical processing module derives the result set by selecting a portion of the second set of measures that remains in the filtered extended table to create the result set.

19. The system of claim 17, further comprising a data foundation module to join two or more of a plurality of database tables stored in memory to provide a comprehensive set of fields used in calculating the set of measures.

20. The system of claim 17, wherein the analytical processing module filters the extended table by selecting rows of data in the extended table that satisfy the filter attribute, and derives the result set by selecting, based on the query, a portion of data in the selected rows of data that satisfy the filter attribute to create the result set.
